(19) United States
(12) Patent Application Publication
(10) Pub. No.: US 2023/0323168 A1
(43) Pub. Date: Oct. 12, 2023

(54) CATECHOL MODIFIERS FOR EPOXY ADHESIVES

(71) Applicant: Zymergen Inc., Emeryville, CA (US)

(72) Inventors: Carol A. KOCH, San Gabriel, CA (US); Joachim RITTER, San Rafael, CA (US); Jose RODRIGUEZ-PARADA, Hockessin, DE (US); Michael F. LEMON, Wilmington, DE (US); Jason SAFKO, Redwood City, CA (US); Md Nazim UDDIN, Berkeley, CA (US); Jenny SHAO, South San Francisco, CA (US)

(21) Appl. No.: 18/020,754

(22) PCT Filed: Aug. 12, 2021
(86) PCT No.: PCT/US2021/045748

§ 371 Date: Feb. 10, 2023

Related U.S. Application Data
(60) Provisional application No. 63/064,743, filed on Aug. 12, 2020.

(51) Int. Cl. C09J 163/00; C09J 11/06

(52) U.S. Cl. CPC C09J 163/00; C09J 11/06

(57) ABSTRACT

The present disclosure provides epoxy adhesive compositions with increased adhesion to surfaces, including metal surfaces, comprising a catechol modifier and methods of use thereof.

### CROSS REFERENCE TO RELATED APPLICATIONS

This application claims the benefit of priority to U.S. Provisional Application No. 63/064,743 filed on Aug. 12, 2020, which is hereby incorporated by reference in its entirety.

### TECHNICAL FIELD

The present disclosure relates to catechol molecules and their use as modifiers for epoxy adhesives. The disclosed modifiers increase performance of an epoxy adhesive by increasing adhesion to surfaces, including metal surfaces.

### BACKGROUND

Epoxy adhesives are widely used as structural adhesives in many applications including, automotive, aeronautic, electronics packaging, and construction. There are many advantages to epoxy adhesives including high mechanical strength, high chemical and environmental resistance, relatively low shrinkage, high temperature resistance, and excellent adhesion. Two component epoxy adhesive formulations offer convenience to the end user by being supplied in a dual cartridge with static mixing tips so that the final formulation can be applied directly to the substrate.

For many applications, existing epoxy adhesives are not sufficient. Thus, there is a need in the art for new epoxy adhesives with enhanced properties.

### SUMMARY

In one aspect, the present disclosure provides an epoxy adhesive composition, comprising:
(a) an epoxy resin;
(b) a catechol modifier selected from the group consisting of:

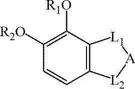

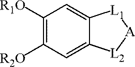

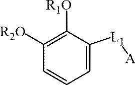

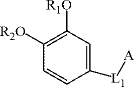

wherein R₁ and R₂ are independently selected from hydrogen and alkyl;
L₁ and L₂ are independently absent or are independently selected linking groups,
A is an epoxy group or a nucleophile that reacts with an epoxy group; wherein when L₁ and L₂ are both present, A is not an epoxy group, and
(c) a hardener.

In some embodiments, the catechol modifier is selected from the group consisting of dopamine, N-octyl dopamine, norlaudanosoline, 2-aminobiphenyl-2,3-diol, 5,6-dihydroxyindole, coclaurine, norcoclaurine, laudanosoline, metanephrine, normetanephrine, adrenaline, and noradrenaline.

In some embodiments, the catechol modifier is an N-alkylated derivative of a catechol selected from the group consisting of dopamine, N-octyl dopamine, norlaudanosoline, 2-aminobiphenyl-2,3-diol, 5,6-dihydroxyindole, coclaurine, norcoclaurine, laudanosoline, metanephrine, normetanephrine, adrenaline, and noradrenaline.

In some embodiments, the epoxy adhesive composition of the present disclosure is prepared by a process comprising reacting protocatechuic acid or an ester thereof with a diamine to provide a catecholamine modifier.

In one aspect, the present disclosure provides a method of coating a substrate, comprising:
(a) applying an epoxy adhesive composition as disclosed herein to the substrate and
(b) curing the composition

In some embodiments, the substrate is a metal substrate. In some embodiments, the metal substrate is selected from the group consisting of aluminum and steel carbon-alloy.

### BRIEF DESCRIPTION OF THE DRAWINGS

FIG. 1 shows lap shear results on metal and plastic substrates for dopamine in bisphenol A diglycidyl ether (D.E.R. 332) with diethylenetriamine (DETA) as hardener after curing at 70° C. for 2 h.

FIG. 2 shows lap shear results on metal substrates for dopamine in D.E.R. 332 with DETA as hardener after curing at 70° C. for 2 h.

FIG. 3 shows lap shear results on metal substrates for dopamine in D.E.R. 332 with 4,7,10-trioxa-1,13-tridecanediamine (TDD) as hardener after curing at 70° C. for 2 h.

FIG. 4 shows lap shear results on metal and plastic substrates for norlaudanosoline in D.E.R. 332 with DETA as hardener after curing at 70° C. for 2 h.

FIG. 5 shows lap shear results on metal substrates for norlaudanosoline in D.E.R. 332 with DETA as hardener after curing at 70° C. for 2 h.

FIG. 6 shows lap shear results on metal substrates for norlaudanosoline in D.E.R. 332 with TDD as hardener after curing at 70° C. for 2 h.

FIG. 7 shows lap shear results for norlaudanosoline-free base in D.E.R. 332 with TDD as hardener after curing at 70° C. for 2 h.

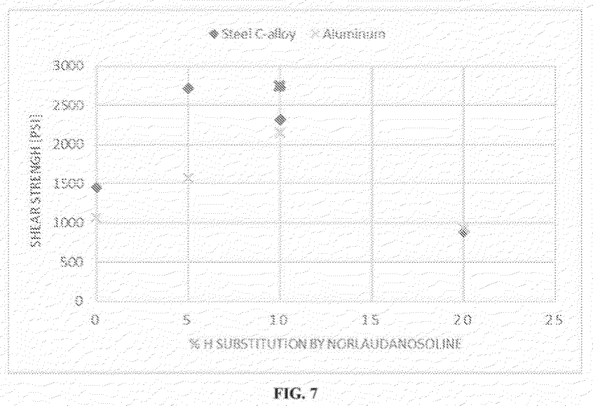

FIG. 8 shows lap shear results on metal substrates for protocatechuic acid (PCA) adduct with TDD (D.E.R. 332 with adduct of PCA/TDD and TDD) as hardener after curing at 70° C. for 2 h.

FIG. 9 shows Tg values and lap shear test results for epoxy adhesive compositions of the present disclosure cured on metal and plastic substrates.

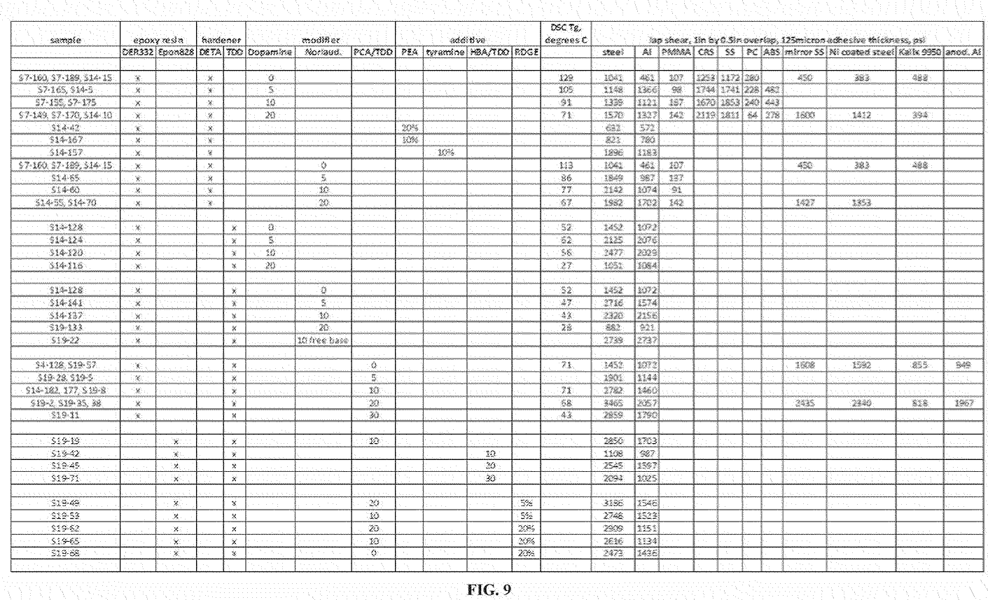

### DEFINITIONS

The term “about” when immediately preceding a numerical value means a range (e.g., plus or minus 10% of that value). For example, “about 50” can mean 45 to 55, “about 25,000” can mean 22,500 to 27,500, etc., unless the context of the disclosure indicates otherwise, or is inconsistent with such an interpretation. For example in a list of numerical values such as “about 49, about 50, about 55, ...”, “about 50” means a range extending to less than half the interval(s) between the preceding and subsequent values, e.g., more than 49.5 to less than 52.5. Furthermore, the phrases “less than about” a value or “greater than about” a value should be understood in view of the definition of the term “about” provided herein. Similarly, the term “about” when preceding a series of numerical values or a range of values (e.g., “about 10, 20, 30” or “about 10-30”) refers, respectively to all values in the series, or the endpoints of the range.

Throughout this disclosure, various patents, patent applications and publications (including non-patent publications) are referenced. The disclosures of these patents, patent applications and publications in their entireties are incorporated into this disclosure by reference for all purposes in order to more fully describe the state of the art as known to those skilled therein as of the date of this disclosure. This disclosure will govern in the instance that there is any inconsistency between the patents, patent applications and publications cited and this disclosure.

For convenience, certain terms employed in the specification, examples and claims are collected here. Unless defined otherwise, all technical and scientific terms used in this disclosure have the same meanings as commonly understood by one of ordinary skill in the art to which this disclosure belongs.

“Alkyl” or “alkyl group” refers to a fully saturated, straight or branched hydrocarbon chain having from one to twelve carbon atoms, and which is attached to the rest of the molecule by a single bond. Alkyls comprising any number of carbon atoms from 1 to 12 are included. An alkyl comprising up to 12 carbon atoms is a C₁-C₁₂ alkyl, an alkyl comprising up to 10 carbon atoms is a C₁-C₁₀ alkyl, an alkyl comprising up to 6 carbon atoms is a C₁-C₆ alkyl and an alkyl comprising up to 5 carbon atoms is a C₁-C₅ alkyl. A C₁-C₅ alkyl includes C₅ alkyls, C₄ alkyls, C₃ alkyls, C₂ alkyls and C₁ alkyl (i.e., methyl). A C₁-C₆ alkyl includes all moieties described above for C₁-C₅ alkyls but also includes C₆ alkyls. A C₁-C₁₀ alkyl includes all moieties described above for C₁-C₅ alkyls and C₁-C₆ alkyls, but also includes C₇, C₈, C₉ and C₁₀ alkyls. Similarly, a C₁-C₁₂ alkyl includes all the foregoing moieties, but also includes C₁₁ and C₁₂ alkyls. Non-limiting examples of C₁-C₁₂ alkyl include methyl, ethyl, n-propyl, i-propyl, sec-propyl, n-butyl, i-butyl, sec-butyl, t-butyl, n-pentyl, t-amyl, n-hexyl, n-heptyl, n-octyl, n-nonyl, n-decyl, n-undecyl, and n-dodecyl. Unless stated otherwise specifically in the specification, an alkyl group can be optionally substituted.

“Alkylene” or “alkylene chain” refers to a fully saturated, straight or branched divalent hydrocarbon chain radical, and having from one to twelve carbon atoms. Non-limiting examples of C₁-C₁₂ alkylene include methylene, ethylene, propylene, n-butylene, and the like. The alkylene chain is attached to the rest of the molecule through a single bond and to a radical group (e.g., those described herein) through a single bond. The points of attachment of the alkylene chain to the rest of the molecule and to the radical group can be through one carbon or any two carbons within the chain. Unless stated otherwise specifically in the specification, an alkylene chain can be optionally substituted.

“Alkenyl” or “alkenyl group” refers to a straight or branched hydrocarbon chain having from two to twelve carbon atoms, and having one or more carbon-carbon double bonds. Each alkenyl group is attached to the rest of the molecule by a single bond. Alkenyl group comprising any number of carbon atoms from 2 to 12 are included. An alkenyl group comprising up to 12 carbon atoms is a C₂-C₁₂ alkenyl, an alkenyl comprising up to 10 carbon atoms is a C₂-C₁₀ alkenyl, an alkenyl group comprising up to 6 carbon atoms is a C₂-C₆ alkenyl and an alkenyl comprising up to 5 carbon atoms is a C₂-C₅ alkenyl. A C₂-C₅ alkenyl includes C₅ alkenyls, C₄ alkenyls, C₃ alkenyls, and C₂ alkenyls. A C₂-C₆ alkenyl includes all moieties described above for C₂-C₅ alkenyls but also includes C₆ alkenyls. A C₂-C₁₀ alkenyl includes all moieties described above for C₂-C₅ alkenyls and C₂-C₆ alkenyls, but also includes C₇, C₈, C₉ and C₁₀ alkenyls. Similarly, a C₂-C₁₂ alkenyl includes all the foregoing moieties, but also includes C₁₁ and C₁₂ alkenyls. Non-limiting examples of C₂-C₁₂ alkenyl include ethenyl (vinyl), 1-propenyl, 2-propenyl (allyl), iso-propenyl, 2-methyl-1-propenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl, 5-hexenyl, 1-heptenyl, 2-heptenyl, 3-heptenyl, 4-heptenyl, 5-heptenyl, 6-heptenyl, 1-octenyl, 2-octenyl, 3-octenyl, 4-octenyl, 5-octenyl, 6-octenyl, 7-octenyl, 1-nonenyl, 2-nonenyl, 3-nonenyl, 4-nonenyl, 5-nonenyl, 6-nonenyl, 7-nonenyl, 8-nonenyl, 1-decenyl, 2-decenyl, 3-decenyl, 4-decenyl, 5-decenyl, 6-decenyl, 7-decenyl, 8-decenyl, 9-decenyl, 1-undecenyl, 2-undecenyl, 3-undecenyl, 4-undecenyl, 5-undecenyl, 6-undecenyl, 7-undecenyl, 8-undecenyl, 9-undecenyl, 10-undecenyl, 1-dodecenyl, 2-dodecenyl, 3-dodecenyl, 4-dodecenyl, 5-dodecenyl, 6-dodecenyl, 7-dodecenyl, 8-dodecenyl, 9-dodecenyl, 10-dodecenyl, and 11-dodecenyl. Unless stated otherwise specifically in the specification, an alkyl group can be optionally substituted.

“Alkenylene” or “alkenylene chain” refers to an unsaturated, straight or branched divalent hydrocarbon chain radical having one or more olefins and from two to twelve carbon atoms. Non-limiting examples of C₂-C₁₂ alkenylene include ethenylene, propenylene, n-butenylene, and the like. The alkenylene chain is attached to the rest of the molecule through a single bond and to a radical group (e.g., those described herein) through a single bond. The points of attachment of the alkenylene chain to the rest of the molecule and to the radical group can be through one carbon or any two carbons within the chain. Unless stated otherwise specifically in the specification, an alkenylene chain can be optionally substituted.

“Aryl” refers to a hydrocarbon ring system comprising hydrogen, 6 to 18 carbon atoms and at least one aromatic ring, and which is attached to the rest of the molecule by a single bond. For purposes of this disclosure, the aryl can be a monocyclic, bicyclic, tricyclic or tetracyclic ring system, which can include fused or bridged ring systems. Aryls include, but are not limited to, aryls derived from aceanthrylene, acenaphthylene, acephenanthrylene, anthracene, azulene, benzene, chrysene, fluoranthene, fluorene, as-indacene, s-indacene, indane, indene, naphthalene, phenalene, phenanthrene, pleiadene, pyrene, and triphenylene. Unless stated otherwise specifically in the specification, the “aryl” can be optionally substituted.

“Carbocyclyl,” “carbocyclic ring” or “carbocycle” refers to a rings structure, wherein the atoms which form the ring are each carbon, and which is attached to the rest of the molecule by a single bond. Carbocyclic rings can comprise from 3 to 20 carbon atoms in the ring. Carbocyclic rings include aryls and cycloalkyl, cycloalkenyl, and cycloalkynyl as defined herein. Unless stated otherwise specifically in the specification, a carbocyclyl group can be optionally substituted.

“Carbocyclylalkyl” refers to a radical of the formula -R_{b}-R_{d} where R_{b} is an alkylene, alkenylene, or alkynylene group as defined above and R_{d} is a carbocyclyl radical as defined above. Unless stated otherwise specifically in the specification, a carbocyclylalkyl group can be optionally substituted.

“Cycloalkyl” refers to a stable non-aromatic monocyclic or polycyclic fully saturated hydrocarbon consisting solely of carbon and hydrogen atoms, which can include fused or bridged ring systems, having from three to twenty carbon atoms (e.g., having from three to ten carbon atoms) and which is attached to the rest of the molecule by a single bond. Monocyclic cycloalkyls include, for example, cyclopropyl, cyclobutyl, cyclopentyl, cyclohexyl, cycloheptyl, and cyclooctyl. Polycyclic cycloalkyls include, for example, adamantyl, norbornyl, decalinyl, 7,7-dimethyl-bicyclo[2.2.1]heptanyl, and the like. Unless otherwise stated specifically in the specification, a cycloalkyl group can be optionally substituted.

“Cycloalkenyl” refers to a stable non-aromatic monocyclic or polycyclic hydrocarbon consisting solely of carbon and hydrogen atoms, having one or more carbon-carbon double bonds, which can include fused or bridged ring systems, having from three to twenty carbon atoms, preferably having from three to ten carbon atoms, and which is attached to the rest of the molecule by a single bond. Monocyclic cycloalkenyls include, for example, cyclopentenyl, cyclohexenyl, cycloheptenyl, cycloctenyl, and the like. Polycyclic cycloalkenyls include, for example, bicyclo[2.2.1]hept-2-enyl and the like. Unless otherwise stated specifically in the specification, a cycloalkenyl group can be optionally substituted.

“Heterocyclyl,” “heterocyclic ring” or “heterocycle” refers to a stable saturated, unsaturated, or aromatic 3- to 20-membered ring which consists of two to nineteen carbon atoms and from one to six heteroatoms selected from the group consisting of nitrogen, oxygen and sulfur, and which is attached to the rest of the molecule by a single bond. Heterocyclycl or heterocyclic rings include heteroaryls, heterocyclylalkyls, heterocyclylalkenyls, and hetercyclylalkynyls. Unless stated otherwise specifically in the specification, the heterocyclyl can be a monocyclic, bicyclic, tricyclic or tetracyclic ring system, which can include fused or bridged ring systems; and the nitrogen, carbon or sulfur atoms in the heterocyclyl can be optionally oxidized; the nitrogen atom can be optionally quaternized; and the heterocyclyl can be partially or fully saturated. Examples of such heterocyclyl include, but are not limited to, dioxolanyl, thienyl[1,3]dithianyl, decahydroisoquinolyl, imidazolinyl, imidazolidinyl, isothiazolidinyl, isoxazolidinyl, morpholinyl, octahydroindolyl, octahydroisoindolyl, 2-oxopiperazinyl, 2-oxopiperidinyl, 2-oxopyrrolidinyl, oxazolidinyl, piperidinyl, piperazinyl, 4-piperidonyl, pyrrolidinyl, pyrazolidinyl, quinuclidinyl, thiazolidinyl, tetrahydrofuryl, trithianyl, tetrahydropyranyl, thiomorpholinyl, thiamorpholinyl, 1-oxo-thiomorpholinyl, and 1,1-dioxo-thiomorpholinyl. Unless stated otherwise specifically in the specification, a heterocyclyl group can be optionally substituted.

“Heteroaryl” refers to a 5- to 20-membered ring system comprising hydrogen atoms, one to nineteen carbon atoms, one to six heteroatoms selected from the group consisting of nitrogen, oxygen and sulfur, at least one aromatic ring, and which is attached to the rest of the molecule by a single bond. For purposes of this disclosure, the heteroaryl can be a monocyclic, bicyclic, tricyclic or tetracyclic ring system, which can include fused or bridged ring systems; and the nitrogen, carbon or sulfur atoms in the heteroaryl can be optionally oxidized; the nitrogen atom can be optionally quaternized. Examples include, but are not limited to, azepinyl, acridinyl, benzimidazolyl, benzothiazolyl, benzindolyl, benzodioxolyl, benzofuranyl, benzooxazolyl, benzothiazolyl, benzothiadiazolyl, benzo[b][1,4]dioxepinyl, 1,4-benzodioxanyl, benzonaphthofuranyl, benzoxazolyl, benzodioxolyl, benzodioxinyl, benzopyranyl, benzopyranonyl, benzofuranyl, benzofuranonyl, benzothienyl (benzothiophenyl), benzotriazolyl, benzo[4,6]imidazo[1,2-a]pyridinyl, carbazolyl, cinnolinyl, dibenzofuranyl, dibenzothiophenyl, furanyl, furanonyl, isothiazolyl, imidazolyl, indazolyl, indolyl, indazolyl, isoindolyl, indolinyl, isoindolinyl, isoquinolyl, indolizinyl, isoxazolyl, naphthyridinyl, oxadiazolyl, 2-oxoazepinyl, oxazolyl, oxiranyl, 1-oxidopyridinyl, 1-oxidopyrimidinyl, 1-oxidopyrazinyl, 1-oxidopyridazinyl, 1-phenyl-1H-pyrrolyl, phenazinyl, phenothiazinyl, phenoxazinyl, phthalazinyl, pteridinyl, purinyl, pyrrolyl, pyrazolyl, pyridinyl, pyrazinyl, pyrimidinyl, pyridazinyl, quinazolinyl, quinoxalinyl, quinolinyl, quinuclidinyl, isoquinolinyl, tetrahydroquinolinyl, thiazolyl, thiadiazolyl, triazolyl, tetrazolyl, triazinyl, and thiophenyl (i.e. thienyl). Unless stated otherwise specifically in the specification, a heteroaryl group can be optionally substituted.

“Alkylenearyl” refers to a radical of the formula -Rᵢ-Rⱼ, wherein Rᵢ is an alkylene and Rⱼ is an aryl, each of which is as defined herein. Unless stated otherwise specifically in this specification, an alkylenearyl group can be optionally substituted.

“Alkyleneheteroaryl” refers to a radical of the formula -Rᵢ-Rⱼ, wherein Ri is an alkylene and Rⱼ is a heteroaryl, each of which is as defined herein. Unless stated otherwise specifically in this specification, an alkyleneheteroaryl group can be optionally substituted.

The term “substituted” used herein means any of the groups described herein (e.g., alkyl, alkenyl, alkynyl, alkoxy, aryl, aralkyl, carbocyclyl, cycloalkyl, cycloalkenyl, cycloalkynyl, haloalkyl, heterocyclyl, and/or heteroaryl) wherein at least one hydrogen atom is replaced by a bond to a non-hydrogen atoms such as, but not limited to: a halogen atom such as F, Cl, Br, and I; an oxygen atom in groups such as hydroxyl groups, alkoxy groups, and ester groups; a sulfur atom in groups such as thiol groups, thioalkyl groups, sulfone groups, sulfonyl groups, and sulfoxide groups; a nitrogen atom in groups such as amines, amides, alkylamines, dialkylamines, arylamines, alkylarylamines, diarylamines, N-oxides, imides, and enamines; a silicon atom in groups such as trialkylsilyl groups, dialkylarylsilyl groups, alkyldiarylsilyl groups, and triarylsilyl groups; and other heteroatoms in various other groups. “Substituted” also means any of the above groups in which one or more hydrogen atoms are replaced by a higher-order bond (e.g., a double- or triple-bond) to a heteroatom such as oxygen in oxo, carbonyl, carboxyl, and ester groups; and nitrogen in groups such as imines, oximes, hydrazones, and nitriles. For example, “substituted” includes any of the above groups in which one or more hydrogen atoms are replaced with —NR_{g}Rₕ, —NR_{g}C(═O)Rₕ, —NR_{g}C(═O)NR_{g}Rₕ, —NR_{g}C(═O)ORₕ, —NR_{g}SO₂Rₕ, —OC(═O)NR_{g}Rₕ, —OR_{g}, —SR_{g}, -SOR_{g}, —SO₂R_{g}, -OSO₂R_{g}, —SO₂OR_{g}, ═NSO₂R_{g}, and —SO₂NR_{g}R_{h.}

“Substituted” also means any of the above groups in which one or more hydrogen atoms are replaced with —C(═O)R_{g}, —C(═O)OR_{g}, —C(═O)NR_{g}Rₕ, —CH₂SO₂R_{g}, —CH₂SO₂NR_{g}R_{h.} In the foregoing, R_{g} and Rₕ are the same or different and independently hydrogen, alkyl, alkenyl, alkynyl, alkoxy, alkylamino, thioalkyl, aryl, aralkyl, cycloalkyl, cycloalkenyl, cycloalkynyl, cycloalkylalkyl, haloalkyl, haloalkenyl, haloalkynyl, heterocyclyl, N-heterocyclyl, heterocyclylalkyl, heteroaryl, N-heteroaryl and/or heteroarylalkyl. “Substituted” further means any of the above groups in which one or more hydrogen atoms are replaced by a bond to an amino, cyano, hydroxyl, imino, nitro, oxo, thioxo, halo, alkyl, alkenyl, alkynyl, alkoxy, alkylamino, thioalkyl, aryl, aralkyl, cycloalkyl, cycloalkenyl, cycloalkynyl, cycloalkylalkyl, haloalkyl, haloalkenyl, haloalkynyl, heterocyclyl, N-heterocyclyl, heterocyclylalkyl, heteroaryl, N-heteroaryl and/or heteroarylalkyl group. In addition, each of the foregoing substituents can also be optionally substituted with one or more of the above substituents.

### DETAILED DESCRIPTION

The present disclosure provides epoxy adhesive compositions that contain catechol modifiers. The catechol modifiers improve epoxy adhesive compositions by, for example, increasing adhesion of the compositions to metal surfaces. This performance improvement may be particularly useful in transportation applications in which it is desirable to replace mechanical fasteners with structural adhesives in order to reduce the weight of the overall assembly. Increased adhesion may also be useful in ensuring the reliability and continued performance in certain applications.

In one aspect, the present disclosure provides an epoxy adhesive composition, comprising:
(a) an epoxy resin;
(b) a catechol modifier selected from the group consisting of:

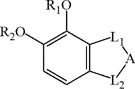

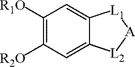

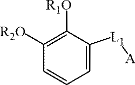

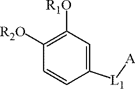

wherein R₁ and R₂ are independently selected from hydrogen and alkyl;
L₁ and L₂ are independently absent or are independently selected linking groups,
A is an epoxy group or a nucleophile that reacts with an epoxy group; wherein when L₁ and L₂ are both present, A is not an epoxy group, and
(c) a hardener.

In some embodiments, R₁ and R₂ are each independently hydrogen or alkyl. In some embodiments, R₁ and R₂ are hydrogen. In some embodiments, R₁ and R₂ are alkyl. In some embodiments, one of R₁ and R₂ is hydrogen and the other is alkyl. In some embodiments, the alkyl is C₁₋₆alkyl. In some embodiments, the alkyl is methyl.

In some embodiments, L₁is alkylene or polyether. In some embodiments, L₁ is selected from the group consisting of alkylene, polyether, -(C=O)NH-polyether-, -(C=O)NH-alkylene-aryl-, -(C=O)NH-aryl-alkylene-, -(C=O)NH-alkylene-aryl-alkylene- and aryl, wherein the alkylene is optionally substituted with one or more substituents independently selected from the group consisting of hydroxyl, and alkylene-aryl, and wherein the alkylene-aryl is optionally substituted by one or more substituents independently selected from hydroxyl and alkoxy. In some embodiments, L₁is selected from the group consisting of alkylene, polyether, -(C=O)NH-polyether- and aryl, wherein the alkylene is optionally substituted with one or more substituents independently selected from the group consisting of hydroxyl, and alkylene-aryl, and wherein the alkylene-aryl is optionally substituted by one or more substituents independently selected from hydroxyl and alkoxy. In some embodiments, L₁is C₁-₃ alkylene, wherein the C₁-₃ alkylene is optionally substituted with -C₁-₃alkylene-aryl, and wherein the -C₁-₃ alkylene-aryl is optionally substituted by one or more hydroxyl groups. In some embodiments, L₁is C₁-₃ alkylene optionally substituted with -CH₂-aryl, wherein the aryl is optionally substituted by one or more hydroxyl groups. In some embodiments, the aryl is optionally substituted by 2 hydroxyl groups. In some embodiments, L₁ is —CH₂CH₂—.

In some embodiments, L₂ is alkylene or polyether. In some embodiments, L₂ is C₁-₆ alkylene. In some embodiments, L₂ is C₁-₃ alkylene. In some embodiments, L₂ is selected from the group consisting of —CH₂— and —CH₂CH₂—. In some embodiments, L₂ is —CH₂CH₂—.

In some embodiments, L₁ and L₂ are alkylene.

In some embodiments, A is a primary amine.

In some embodiments, A is a secondary amine. In some embodiments A is —NH—.

In some embodiments, A is —NR³— or —NR³R⁴, wherein R³ and R⁴ are independently selected from the group consisting of hydrogen, alkyl, heterocyclyl, cycloalkyl, aryl and heteroaryl. In some embodiments, R³ and R⁴ are H, or -C₁₋₁₀ alkyl.

In some embodiments, A is an epoxy group.

In some embodiments, L₁-A is selected from the group consisting of -(C=O)NH-alkylene-aryl-A; -(C=O)NH-aryl-alkylene-A; -(C=O)NH-alkylene-aryl-alkylene-A; —(C═O)NH—alkylene-A; -(C=O)NH-polyether-A; -(C=O)O-alkylene-A; and -(C=O)O-polyether- A.

In some embodiments, L₁-A is selected from the group consisting of -(C=O)NH-alkylene-A; -(C=O)NH-polyether-A; -(C=O)O-alkylene-A; and -(C=O)O-polyether-A.

In some embodiments, L₁-A is selected from the group consisting of —(C═O)NH—(CH₂)₄—NH₂; —(C═O)NH—(CH₂)₂—NH—(CH₂)₂—NH₂; —(C═O)NH—(CH₂)₃—NH—(CH₂CH₂OH); and —(C═O)NH—(CH₂)₂—O—(CH₂)₂)—O—(CH₂)₂—NH₂.

In some embodiments, the catechol modifier is selected from the group consisting of:

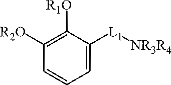

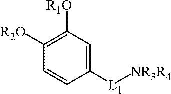

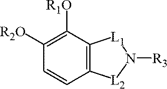

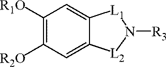

wherein R₃ and R₄ independently selected from hydrogen, alkyl, heterocyclyl, cycloalkyl, aryl or heteroaryl.

In some embodiments R³ and R⁴, are independently selected from the group consisting of H, and -C₁₋₁₀ alkyl.

In some embodiments, the catechol modifier is a compound of formula:

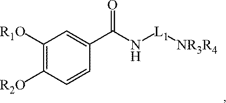

wherein R₃ and R₄ are independently selected from the group consisting of hydrogen, alkyl, heterocyclyl, cycloalkyl, aryl and heteroaryl.

In some embodiments, R₃ is hydrogen and R₄ is alkyl.

In some embodiments, R₃ and R₄ are hydrogen.

In some embodiments, L₁is -C₁₋₆alkylene-(OCH₂CH₂)₁₋₃-C₁₋₆alkylene-.

In some embodiments, the catechol modifier is selected from the group consisting of dopamine, N-octyl dopamine, norlaudanosoline, 2-aminobiphenyl-2,3-diol, 5,6-dihydroxyindole, coclaurine, norcoclaurine, laudanosoline, metanephrine, normetanephrine, adrenaline, and noradrenaline.

In some embodiments, the catechol modifier is a N-alkylated derivative of a catechol selected from the group consisting of dopamine, N-octyl dopamine, norlaudanosoline, 2-aminobiphenyl-2,3-diol, 5,6-dihydroxyindole, coclaurine, norcoclaurine, laudanosoline, metanephrine, normetanephrine, adrenaline, and noradrenaline.

In some embodiments, the catechol modifier is prepared by a process comprising: reacting a catecholamine and a bisepoxy compound to provide a catechol modifier containing an epoxy group. In some embodiments, the catecholamine is selected from the group consisting of dopamine, N-octyl dopamine, norlaudanosoline, 2-aminobiphenyl-2,3-diol, 5,6-dihydroxyindole, coclaurine, norcoclaurine, laudanosoline, metanephrine, normetanephrine, adrenaline, and noradrenaline.

In some embodiments, the bisepoxy compound is selected from the group consisting of butane diepoxide, D.E.R. 332, Epon 828, Epon 834, D.E.R. 732, and D.E.R. 736.

In some embodiments, the bisepoxy compound is selected from the group consisting of butane diepoxide, D.E.R. 332, and Epon 828,

In some embodiments, the catechol modifier is prepared by a process comprising: reacting protocatechuic acid or an ester thereof with a diamine to provide a catecholamine modifier. In some embodiments, the diamine is selected from the group consisting of 4,7,10-Trioxa-1,13-tridecanediamine (TDD), diaminobutane, jeffamine 148. In some embodiments, the diamine is selected from the group consisting of diaminobutane, DETA, APEA, and Jeffamine 148.

In some embodiments, R₁ and R₂ are hydrogen. In some embodiments, R₁ and R₂ are alkyl. In some embodiments, one of R₁ and R₂ is hydrogen and the other is alkyl.

In some embodiments, the epoxy resin is selected from the group consisting of Epon 828 and D.E.R. 332.

As noted above, the epoxy adhesive composition of the present disclosure comprises a hardener. The hardener can be any hardener known in the art. In some embodiments, the hardener is an amine hardener or an amide hardener. In some embodiments, the hardener is an amine hardener. In some embodiments, the hardener is an amide hardener. In some embodiments, the amine hardener is an optionally substituted aliphatic or optionally substituted cycloaliphatic polyamine. In some embodiments, the amine hardener is selected from the group consisting of diaminobutane, diethylenetriamine (DETA), triethyleneglycol diamine, aminopropyl ethanolamine (APEA) and 4,7,10-trioxa-1,13-tridecanediamine (TDD). In some embodiments, the amine hardener is ethylenediamine (EDA), diethylenetriamine (DETA), triethylenetetramine (TETA), tetraethylenepentamine (TEP .4.), polyoxypropylenediamine, polyoxypropylenetriamine, isophorone diamine, menthane diamine, bis(4-amino-3-methyldicyclohexyl)methane, aminopropyl ethanolamine (APEA) and 4,7,10-trioxa-1,13-tridecanediamine (TDD) and the like.

In some embodiments, the composition further comprises one or more additives selected from the group consisting of a diluent, filler, accelerator, conductive particle, toughening agent, adhesion promoter, and stabilizer.

In some embodiments, the reactive diluent is selected from the group consisting of resorcinol diglycidyl ether (RGDE), phenylglycidyl ether, butylglycidyl ether, allylglycidyl ether, butanediol diglycidyl ether, and 4,4′-Methylenebis(N,N-diglycidylaninline) (MbDGA).

In some embodiments, the diluent is a reactive diluent. In some embodiments, the reactive diluent is selected from the group consisting of resorcinol diglycidyl ether (RGDE), phenylglycidyl ether, butylglycidyl ether, allylglycidyl ether, and butanediol diglycidyl ether. In some embodiments, the reactive diluent is resorcinol diglycidyl ether (RGDE).

In some embodiments, the filler is selected from the group consisting of an alumino-silicate ash, chalk, talc, marble dust or limestone sand, chopped glass fiber, and powdered slate and ground olive stones.

In some embodiments, the accelerator is selected from the group consisting of a modified aliphatic amine, imidazole and substituted urea. In some embodiments, the accelerator is DMP30.

In some embodiments, the conductive particle is selected from the group consisting Ag powder, Ni powder, Ni flakes, Cu powder, and Ni filaments.

In some embodiments, the toughening agent is selected from the group consisting of rubber and thermoplastic polymers.

In some embodiments, the adhesion promoter is a silane.

In some embodiments, the stabilizer is a hindered amine light stabilizer.

In some embodiments, the composition comprises from about 5% to about 30% by weight of the catechol modifier. In some embodiments, the composition comprises from about 1% to about 50%, including about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, to about 50%, by weight of the catechol modifier, including all ranges therebetween.

In one aspect, the present disclosure provides a method of coating a substrate, comprising: (a) applying an epoxy adhesive composition of the present disclosure to the substrate and (b) curing the composition.

In some embodiments, the substrate is a metal substrate. In some embodiments, the metal substrate is selected from the group consisting of aluminum and steel carbon-alloy. In some embodiments, the metal substrate is selected from the group consisting of aluminum, steel carbon-alloy, nickel coated steel, and steel.

In some embodiments, the epoxy adhesive composition comprises from about 5% to about 30% by weight of the catechol modifier, including from about 10%, about 15%, about 20%, about 25%, to about 30% by weight and all ranges therebetween. In some embodiments, the epoxy adhesive composition comprises about 5% by weight, about 10% by weight, about 15% by weight, about 20% by weight, about 25% by weight, to about 30% by weight of the catechol modifier.

In some embodiments, the epoxy adhesive composition comprises about 5% to about 30% H substitution by a catechol amine modifier (e.g., as described herein), including from about 10%, about 15%, about 20%, about 25%, to about 30% H substitution by a catechol amine modifier and all ranges therebetween. In some embodiments, the epoxy adhesive composition forms an adhesive with about 5%, about 10%, about 15%, about 20%, about 25%, to about 30% H substitution by a catechol amine modifier. %H substitution refers to % of H in the traditional amine hardener substituted by the catechol amine hydrogens.

In some embodiments, curing comprises heating the coated substrate to at least about 45° C. In some embodiments, curing comprises heating the coated substrate to from about 45° C. to about 100° C., including about 50° C., about 55° C., about 60° C., about 65° C., about 70° C., about 75° C., about 80° C., about 85° C., about 90° C., about 95° C., to about 100° C. and all ranges therebetween. In some embodiments, curing comprises heating the coated substrate to about 70° C. In some embodiments, curing comprises heating for at least about 2 hours. In some embodiments, curing comprises heating for about 0.5 hour, about 1 hour, about 1.5 hours, about 2 hours, about 2.5 hours, or about 3 hours.

In some embodiments, the cured epoxy adhesive composition has a T_{g} value of about 30° C. to about 150° C. In some embodiments, the cured epoxy adhesive composition has a T_{g} value of about 30° C., about 40° C., about 50° C., about 60° C., about 70° C., about 80° C., about 90° C., about 100° C., about 110° C., about 120° C., about 130° C., about 140° C., to about 150° C. including all ranges therebetween. In some embodiments, the cured epoxy adhesive composition has a T_{g} value of about 40° C. to about 130° C. In some embodiments, the cured epoxy adhesive composition has a T_{g} value of about 30° C., about 40° C., about 50° C., about 60° C., about 70° C., about 80° C., about 90° C., about 100° C., about 110° C., about 120° C., about 130° C., about 140° C., or about 150° C.

In some embodiments, the cured epoxy adhesive composition has a lap shear strength as determined by ASTM D1002-10 of at least 14.5 psi. ASTM standards D1002-10 (“Standard Test Method for Apparent Shear Strength of Single-Lap-Joint Adhesively Bonded Metal Specimens by Tension Loading (Metal-to-Metal)”) is a test method for determining bonding characteristics of adhesives joining various materials. The test results are all reported in force per area, e.g. in psi or N/mm².

In some embodiments, the cured epoxy adhesive composition has a lap shear strength in accordance with ASTM D1002 of at least about 30 psi, at least about 60 psi, at least about 90 psi, at least about 120 psi, at least about 150 psi, at least about 200 psi, at least about 300 psi, at least about 350 psi, at least about 400 psi, at least about 450 psi, at least about 500 psi, at least about 550 psi, at least about 600 psi, at least about 650 psi, at least about 700 psi, at least about 800 psi, at least about 900 psi, at least about 1000 psi, at least about 1100 psi, at least about 1200 psi, at least about 1300 psi, at least about 1400 psi, at least about 1500 psi, at least about 1600 psi, at least about 1700 psi, at least about 1800 psi, at least about 1900 psi, at least about 2000 psi, at least about 2100 psi, at least about 2200 psi, at least about 2300 psi, at least about 2400 psi, at least about 2500 psi, at least about 2600 psi, at least about 2700 psi, at least about 2800 psi, at least about 2900 psi, at least about 3000 psi, at least about 3600 psi, at least about 4400 psi, at least about 5000 psi, at least about 5800 psi, or at least about 6500 psi.

In some embodiments, the cured epoxy adhesive composition has a lap shear strength in accordance with ASTM D1002 of not greater than 22000 psi, not greater than 15000 psi, not greater than 12000 psi, not greater than 9000 psi, not greater than 7000 psi, not greater than 6000 psi, not greater than 5000 psi, not greater than 4000 psi, not greater than 3000 psi, not greater than 1500 psi, not greater than 700 psi, or not greater than 400 psi. In some embodiments, the cured epoxy adhesive composition has a lap shear strength in accordance with ASTMD1002 in the range from about 15 psi to about 12000 psi, from about 30 psi to about 7000 psi, from about 45 psi to about 4000 psi, from 700 psi to about 2900 psi, or from about 1500 psi to about 2900 psi.

### EXAMPLES

### General Protocol for Lap Shear Strength Tests

Six individual substrates are selected to form 3 pairs of Lap Shear Samples. On both the top and bottom substrates ½” active area for the adhesive pad is measured. Dry Abrasion of the ½” active area is done by using a fresh piece of 3 M Scotch Brite 96-20 Professional, General Purpose Scouring Pad. The scouring pad is rubbed over the active area by hand, (with moderate force), 35 times in a forward direction and a subsequent 35 times in a back direction, perpendicular to the width of the substrate. All substrates are solvent cleaned by soaking in Isopropyl Alcohol for 3-5 minutes at room temperature, removed from the soaking tray, sprayed with fresh IPA from a squeeze bottle, then immediately wiped dry using a clean lint free KimWipe. To make the samples -Formulations mixed in a Thinky mixer/ Defoam unit. A plastic pipette is used to evenly dispense Adhesive onto the ½” active area. After this two “127 micron diameter NiCr spacer wires (typically 1.25” lengths) are placed on each sample. The dry mating substrate is placed on the adhesive to align with the active area. ½” binder clips are then used to clamp the substrates together.

Cure conditions: 3 Hrs @ Room Temp/Ramp to 70° C./ Hold @ 70° C. for 2 Hrs. Instrument: Instron 5567 test frame and 1 inch wide wedge grips. Deformation rate = 0.05 inches/min (~1.27 mm/min).

### Example 1. Synthesis of PCA and TDD Adduct

Protocatechuic acid (PCA) ethyl ester (10 g, 0.055 mol) and 4,7,10-Trioxa-1,13-tridecanediamine (TDD) (36 g, 0.055 mol) were added to a round bottom flask equipped with magnetic stirring under an atmosphere of nitrogen. The flask was heated in an oil bath to 130° C. for 24 hrs. After cooling to room temperature, a yellow viscous liquid was obtained. NMR indicated over 80% conversion to the amide. The characteristic peak associated with the newly formed amide bond was observed at 8 ppm. The resulting mixture was used as is for adhesive formulations.

### Example 2. Preparation of Dopamine and D.E.R.™ 332 Formulation

Dopamine hydrochloride (2.1512 g) was weighed in a vial and DMF (6 g) was added. The solid dissolved completely after a few minutes to give a clear and slightly yellow solution. Triethylamine (1.1438 g) was added to the vial and a precipitate (triethylammonium hydrochloride) formed immediately. The mixture was stirred for 5 minutes and then the precipitate was filtered off using a syringe filter. The filtered solution (7.9801 g, >90% recovery) was placed in a round bottom flask and D.E.R.™ 332 (20.23 g) was added. The flask was attached to a rotary evaporator under nitrogen atmosphere at room temperature. The initial viscous mixture was cloudy. DSC of this mixture showed two small exotherms in the first heating scan with peaks at 103° C. and 153° C. The first corresponds to the reaction of the —NH₂ group of dopamine with the epoxy groups of D.E.R.™ 332 while the high temperature exotherm corresponds to the reaction of the phenol groups of dopamine with epoxy. TGA of the mixture shows a weight loss of about 15%, roughly equal to the amount of DMF in the sample. After rotating overnight at room temperature the reaction mixture became completely transparent. Vacuum was applied and the solution was heated < 50° C. and rotated until most of the DMF solvent was evaporated (2-3 hours). The residual amount of solvent, as determined by TGA, was typically 3%. DSC of the final mixture showed only the exotherm at 153° C., indicating that all amino groups had reacted. The final product was a clear viscous liquid that contains short oligomers of the diepoxy with dopamine pendant groups. This material was then used to mix with multifunctional crosslinkers to make the final adhesive.

The above procedure can be used to form formulations with the free base of norlaudanosoline as the catechol amine component. The HBr salt of norlaudanosoline is also compatible with epoxy resins and was added to formulations to show increasing adhesive strength.

### Example 3. Effect of Catecholamine Modifiers on the Lap Shear Strength of Adhesive Formulations.

### Dopamine in DER332 With DETA.

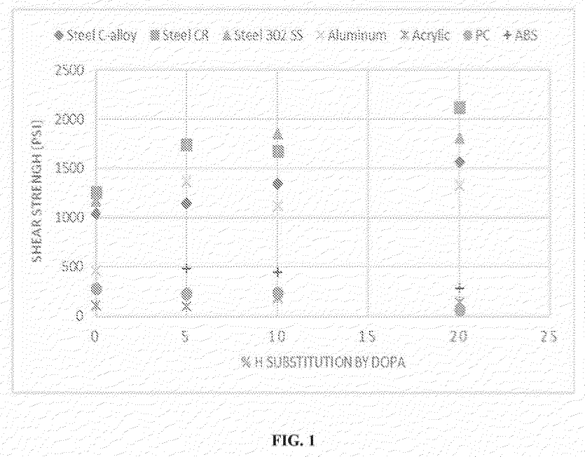

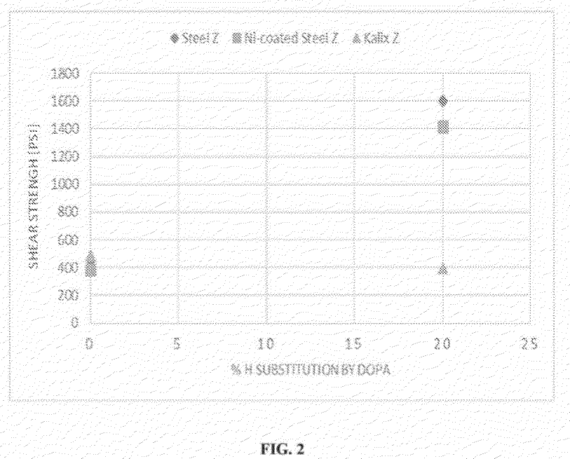

Adhesive formulations containing varying amounts of dopamine in DER332 and diethylenetriamine (DETA) as the hardener were pre-mixed, coated on metal and plastic substrates, cured at 70° C. for 2 hours and the lap shear strength was tested. In these experiments DER 332 and DETA were reacted in a 1:1 ratio. One epoxy group is equivalent to one active hydrogen in the amine hardener. In order to add bio-based amine dopamine the DETA amine hydrogen (%H) was replaced by dopamine hydrogen (5%, 10%, 15% and 20%). As shown in FIG. 1 and FIG. 2 increasing %H substitution by dopamine increased the lap shear on metal substrates, while the lap shear on plastics did not increase.

### Dopamine in DER332 With TDD.

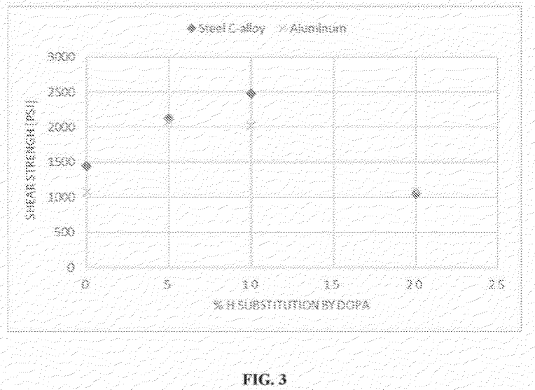

Adhesive formulations containing varying amounts of dopamine in DER332 and 4,7,10-trioxa-1,13-tridecanediamine (TDD) as the hardener were pre-mixed, coated on steel C-alloy and aluminum substrates, cured at 70° C. for 2 hours and the lap shear strength was tested. In these experiments DER 332 and TDD were reacted in a 1:1 ratio. One epoxy group is equivalent to one active hydrogen in the amine hardener. In order to add bio-based amine dopamine the TDD amine hydrogen (%H) was replaced by dopamine hydrogen (5%, 10%, 15% and 20%). As shown in FIG. 3 the highest adhesion was seen when dopamine was incorporated at the 10% H substitution level.

### Norlaudanosoline in DER332 With DETA.

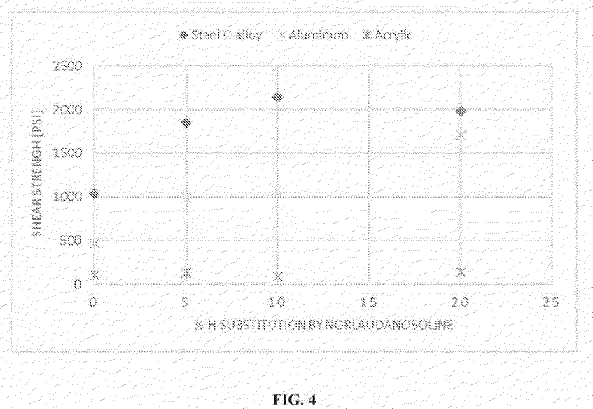

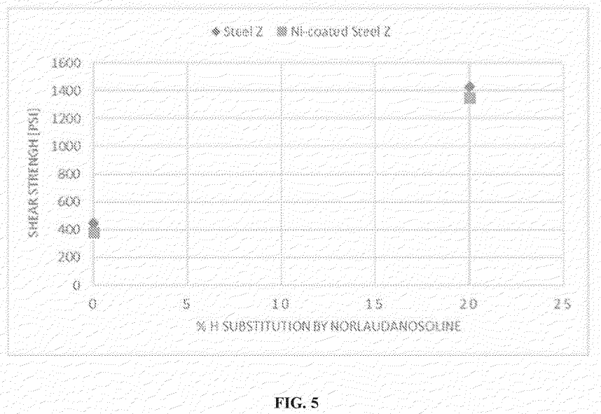

Norlaudanosoline HBr was converted to the free base with triethylamine, and adhesive formulations containing varying amounts of norlaudanosoline in DER332 with DETA as the hardener were pre-mixed, coated on metal and plastic substrates, cured at 70° C. for 2 hours and the lap shear strength was tested. As shown in FIG. 4 incorporation of norlaudanosoline at the 10% H substation level, increased shear strength from 1000 to 2100 psi on steel and from 500 to 1000 psi on Al. No increase in shear strength was observed with the PMMA substrate. As shown in FIG. 5 incorporation of norlaudanosoline at the 20%H substation level, increased shear strength from 400 to 1400 psi on steel Z and Ni-coated steel Z.

### Norlaudanosoline in DER332 With TDD.

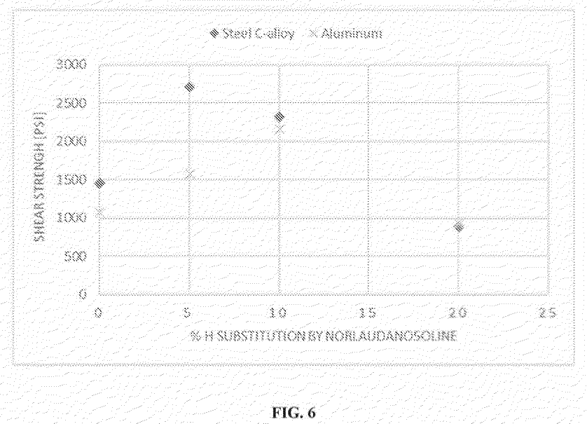

Norlaudanosoline HBr was converted to the free base with triethylamine, and adhesive formulations containing varying amounts of norlaudanosoline in DER332 and TDD as the hardener were pre-mixed, coated on metal substrates, cured at 70° C. for 2 hours and the lap shear strength was tested. As shown in FIG. 6 incorporation of norlaudanosoline at the 5% substitution level shows an increase in shear strength from 1500 to 2700 psi on steel, while the 10% substitution level shows an increase in shear strength from 1000 to 2100 psi on Al.

### PCA/TDD Adduct in DER332 and TDD.

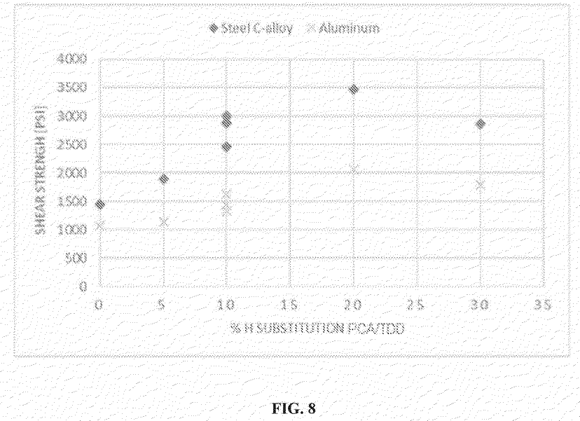

Adhesive formulations containing varying amounts of protocatechuic acid/TDD adduct in DER332 with TDD as the hardener were pre-mixed, coated on metal substrates, cured at 70° C. for 2 hours and the lap shear strength was tested. As shown in FIG. 8 incorporation of protocatechuic acid/TDD adduct showed a maximum lap shear of 3500 psi at 20% substitution level of amine compared to 1500 psi for the control (0% PCA/TDD).

### Example 4. Comparison of Dopamine, Tyramine and Phenethylamine Modifiers on the Lap Shear Strength of Adhesive Formulations.

As shown in Table 1, the lap shear results of formulations containing tyramine and phenethylamine are not as high as the formulation containing dopamine indicating that the catechol functionality is necessary for the increased adhesion (Table 1).

TABLE 1

| Formulation | Additive | % H Substitution | Lap Shear Strength [psi] | |
|---|---|---|---|---|
| | | | Aluminum | Steel C-alloy |
| DER332, TDD | Control | 0 | 1072 | 1452 |
| DER332, TDD, Dopamine (10%H substitution) | DOPA | 10 | 2029 | 2477 |
| DER332, DETA | Tyramine | 10 | 1183 | 1896 |
| DER332, DETA | Phenethylamine | 10 | 780 | 821 |

*All samples cured for 2 hrs at 70° C. DER332:TDD = 2:1 molar ratio. DER332:DETA = 2.5:1 molar ratio.

### Example 5 Effect of Modifiers on Cure Temperature and Gel Time

As shown in Table 2, the cure temperature and gel time of formulations containing different modifiers were measured to determine whether the modifiers act as accelerators and increase the rate of reaction. Gel time is defined as the G′, G″ crossover in an isothermal run at 100, 70, 45, and 30° C. Formulations were produced at 10% based on amine H.

TABLE 2

| Formulation | Cure temp (°C) | Gel Time |
|---|---|---|
| | | min |
| Epon 828 + TDD | 100 | 6 |
| | 70 | 24 |
| | 45 | 120 |
| | 30 | |
| Epon 828 + TDD + DMP30 | 100 | 4 |
| | 70 | 21 |
| | 45 | 95 |
| | 30 | |
| Epon 828 + TDD + tyramine | 100 | 3 |
| | 70 | 14 |
| | 45 | 67 |
| | 30 | 170 |
| Epon 828 + TDD + octanoyl dopamine | 100 | 1 |
| | 70 | 5 |
| | 45 | 28 |
| | 30 | 64 |
| Epon 828 + TDD + PCA/TDD adduct | 100 | 2.5 |
| | 70 | 13 |
| | 45 | 64 |
| | 30 | |

### Numbered Embodiments of the Disclosure

1. An epoxy adhesive composition, comprising:
(a) an epoxy resin;
(b) a catechol modifier selected from the group consisting of:

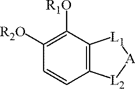

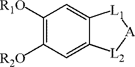

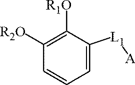

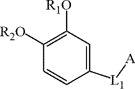

wherein R₁ and R₂ are independently selected from hydrogen and alkyl;
L₁ and L₂ are independently absent or are independently selected linking groups,
A is an epoxy group or a nucleophile that reacts with an epoxy group; wherein when L₁ and L₂ are both present, A is not an epoxy group, and
(c) a hardener.

2. The epoxy adhesive composition of embodiment 1, wherein L₁is alkylene or polyether.

3. The epoxy adhesive composition of embodiment 1 or 2, wherein L₂ is alkylene or polyether.

4. The epoxy adhesive composition of embodiment 1, wherein L₁and L₂ are alkylene.

5. The epoxy adhesive composition of any one of embodiments 1-4, wherein A is a primary amine.

6. The epoxy adhesive composition of any one of embodiments 1-4, wherein A is a secondary amine.

7. The epoxy adhesive composition of any one of embodiments 1-4, wherein A is an epoxy group.

8. The epoxy adhesive composition of embodiment 1, wherein L₁-A is selected from the group consisting of -(C=O)NH-alkylene-aryl-A; -(C=O)NH-aryl-alkylene-A; -(C=O)NH-alkylene-aryl-alkylene-A; -(C=O)NH-alkyl-A; -(C=O)NH-polyether-A; -(C=O)O-alkylene-A; and -(C=O)O-polyether- A.

8a. The epoxy adhesive composition of embodiment 8, wherein L₁-A is -(C=O)NH-alkylene-aryl-A.

8b. The epoxy adhesive composition of embodiment 8, wherein L₁-A is -(C=O)NH-aryl-alkylene-A.

8c. The epoxy adhesive composition of embodiment 8, wherein L₁-A is -(C=O)NH-alkylene-aryl-alkylene-A.

8d. The epoxy adhesive composition of embodiment 8, wherein L₁-A is -(C=O)NH-polyether-A.

9. The epoxy adhesive composition of embodiment 1, wherein L₁-A is selected from the group consisting of —(C═O)NH—(CH₂)₄—NH₂; —(C═O)NH—(CH₂)₂—NH—(CH₂)₂—NH₂; —(C═O)NH—(CH₂)₃—NH—(CH₂CH₂OH); and —(C═O)NH—(CH₂)₂—O—(CH₂)₂)—O—(CH₂)₂—NH₂.

10. The epoxy adhesive composition of embodiment 1 or 2, wherein the catechol modifier is selected from the group consisting of:

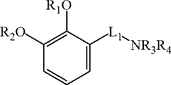

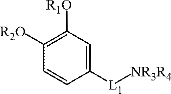

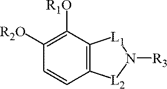

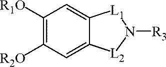

wherein R₃ and R₄ independently selected from hydrogen, alkyl, heterocyclyl, cycloalkyl, aryl or heteroaryl.

11. The epoxy adhesive composition of embodiment 1 or 2, wherein the catechol modifier is a compound of formula:

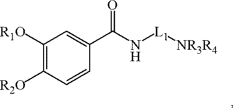

wherein R₃ and R₄ are independently selected from the group consisting of hydrogen, alkyl, heterocyclyl, cycloalkyl, aryl and heteroaryl.

12. The epoxy adhesive composition of embodiment 10 or 11, wherein R₃ is hydrogen and R₄ is alkyl.

13. The epoxy adhesive composition of embodiment 10 or 11, wherein R₃ and R₄ are hydrogen.

14. The epoxy adhesive composition of embodiment 1, wherein the catechol modifier is selected from the group consisting of dopamine, N-octyl dopamine, norlaudanosoline, 2-aminobiphenyl-2,3-diol, 5,6-dihydroxyindole, coclaurine, norcoclaurine, laudanosoline, metanephrine, normetanephrine, adrenaline, and noradrenaline.

15. The epoxy adhesive composition of embodiment 1, wherein the catechol modifier is a N-alkylated derivative of a catechol selected from the group consisting of dopamine, N-octyl dopamine, norlaudanosoline, 2-aminobiphenyl-2,3-diol, 5,6-dihydroxyindole, coclaurine, norcoclaurine, laudanosoline, metanephrine, normetanephrine, adrenaline, and noradrenaline.

16. The epoxy adhesive composition of embodiment 1, wherein the catechol modifier is prepared by a process comprising:

reacting a catecholamine and a bisepoxy compound to provide a catechol modifier containing an epoxy group.

17. The epoxy adhesive composition of embodiment 16, wherein the catecholamine is selected from the group consisting of dopamine, N-octyl dopamine, norlaudanosoline, 2-aminobiphenyl-2,3-diol, 5,6-dihydroxyindole, coclaurine, norcoclaurine, laudanosoline, metanephrine, normetanephrine, adrenaline, and noradrenaline.

18. The epoxy adhesive composition of embodiment 16 or 17, wherein the bisepoxy compound is selected from the group consisting of butane diepoxide, D.E.R. 332, and Epon 828, Epon 834, D.E.R. 732, D.E.R. 736.

19. The epoxy adhesive composition of embodiment 1, wherein the catechol modifier is prepared by a process comprising: reacting a catecholamine and diamine compound to provide a catechol modifier.

20. The epoxy adhesive composition of embodiment 19, wherein the catecholamine is protocatechuic acid or an ester thereof.

21. The epoxy adhesive composition of embodiment 19 or 20, wherein the diamine is selected from the group consisting of 4,7,10-trioxa-1,13-tridecanediamine (TDD), diaminobutane, and jeffamine 148.

22. The epoxy adhesive composition of any one of embodiments 1-21, wherein R₁ and R₂ are hydrogen.

23. The epoxy adhesive composition of any one of embodiments 1-21, wherein R₁ and R₂ are alkyl.

24. The epoxy adhesive composition of any one of embodiments 1-21, wherein one of R₁ and R₂ is hydrogen and the other is alkyl.

25. The epoxy adhesive composition of any one of embodiments 1-24, wherein the epoxy resin is selected from the group consisting of Epon 828 and D.E.R. 332.

26. The epoxy adhesive composition of embodiment 25, wherein the hardener is an amine hardener or amide hardener.

27. The epoxy adhesive composition of embodiment 26, wherein the amine hardener is selected from the group consisting of diaminobutane, diethylenetriamine (DETA), triethyleneglycol diamine, aminopropyl ethanolamine (APEA) and 4,7,10-trioxa-1,13-tridecanediamine (TDD).

28. The epoxy adhesive composition of any one of embodiments 1-27, wherein the composition further comprises one or more additives selected from the group consisting of a diluent, filler, accelerator, conductive particle, toughening agent, adhesion promoter, and stabilizer.

29. The epoxy adhesive composition of embodiment 28, wherein the diluent is a reactive diluent.

30. The epoxy adhesive composition of embodiment 29, wherein the reactive diluent is selected from the group consisting of resorcinol diglycidyl ether (RGDE), phenylglycidyl ether, butylglycidyl ether, allylglycidyl ether, butanediol diglycidyl ether, and 4,4′-methylenebis(N,N-diglycidylaninline) (MbDGA).

31. The epoxy adhesive composition of embodiment 29 or 30, wherein the reactive diluent is resorcinol diglycidyl ether (RGDE).

32. The epoxy adhesive composition of embodiment 28, wherein the filler is selected from the group consisting of an alumino-silicate ash, chalk, talc, marble dust or limestone sand, chopped glass fiber, and powdered slate and ground olive stones.

33. The epoxy adhesive composition of embodiment 28, wherein the accelerator is selected from the group consisting of a modified aliphatic amine, imidazole and substituted urea.

34. The epoxy adhesive composition of embodiment 28, wherein the accelerator is DMP30.

35. The epoxy adhesive composition of embodiment 28, wherein the conductive particle is selected from the group consisting Ag powder, Ni powder, Ni flakes, Cu powder, and Ni filaments.

36. The epoxy adhesive composition of embodiment 28, wherein the toughening agent is selected from the group consisting of rubber and thermoplastic polymers.

37. The epoxy adhesive composition of embodiment 28, wherein the adhesion promoter is a silane.

38. The epoxy adhesive composition of embodiment 28, wherein the stabilizer is a hindered amine light stabilizer.

39. The epoxy adhesive composition of any one of embodiments 1-38, wherein the composition comprises from about 5% to about 30% by weight of the catechol modifier.

40. A method of coating a substrate, comprising:
(a) applying the epoxy adhesive composition of any one of embodiments 1-39 to the substrate; and
(b) curing the composition.

41. The method of embodiment 40, wherein the substrate is a metal substrate.

42. The method of embodiment 41, wherein the metal substrate is selected from the group consisting of aluminum and steel carbon-alloy.

43. The method of any one of embodiments 40-42, wherein the curing comprises heating the coated substrate to at least about 45° C.

44. The method of any one of embodiments 40-42, wherein the curing comprises heating the coated substrate to from about 45° C. to about 100° C.

1. An epoxy adhesive composition, comprising:
(a) an epoxy resin;
(b) a catechol modifier selected from the group consisting of: 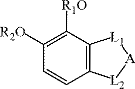 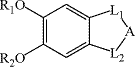 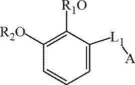 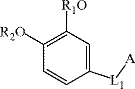
wherein R₁ and R₂ are independently selected from hydrogen and alkyl;
L₁ and L₂ are independently absent or are independently selected linking groups,
A is an epoxy group or a nucleophile that reacts with an epoxy group; wherein when L₁ and L₂ are both present, A is not an epoxy group, and
(c) a hardener.

2. The epoxy adhesive composition of claim 1, wherein L₁ is alkylene or polyether.

3. The epoxy adhesive composition of claim 1 or 2, wherein L₂ is alkylene or polyether.

4. The epoxy adhesive composition of claim 1, wherein L₁ and L₂ are alkylene.

5. The epoxy adhesive composition of any one of claims 1-4, wherein A is a primary amine.

6. The epoxy adhesive composition of any one of claims 1-4, wherein A is a secondary amine.

7. The epoxy adhesive composition of any one of claims 1-4, wherein A is an epoxy group.

8. The epoxy adhesive composition of claim 1, wherein L₁-A is selected from the group consisting of -(C=O)NH-alkylene-aryl-A; -(C=O)NH-aryl-alkylene-A; -(C=O)NH-alkylene-aryl-alkylene-A; -(C=O)NH-alkyl-A; -(C=O)NH-polyether-A; -(C=O)O-alkylene-A; and -(C=O)O-polyether- A.

9. The epoxy adhesive composition of claim 8, wherein L₁-A is -(C=O)NHalkylene-aryl-A.

10. The epoxy adhesive composition of claim 8, wherein L₁-A is -(C=O)NH-arylalkylene-A.

11. The epoxy adhesive composition of claim 8, wherein L₁-A is -(C=O)NHalkylene-aryl-alkylene-A.

12. The epoxy adhesive composition of claim 8, wherein L₁-A is -(C=O)NHpolyether-A.

13. The epoxy adhesive composition of claim 1, wherein L₁-A is selected from the group consisting of —(C═O)NH—(CH₂)₄—NH₂; —(C═O)NH—(CH₂)₂—NH—(CH₂)₂—NH₂; —(C═O)NH—(CH₂)₃—NH—(CH₂CH₂OH); and —(C═O)NH—(CH₂)₂—O—(CH₂)₂)—O—(CH₂)₂—NH₂.

14. The epoxy adhesive composition of claim 1 or 2, wherein the catechol modifier is selected from the group consisting of: 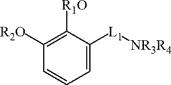 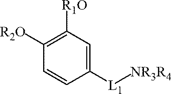 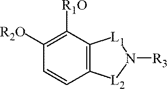 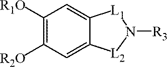
wherein R₃ and R₄ independently selected from the group consisting of hydrogen, alkyl, heterocyclyl, cycloalkyl, aryl and heteroaryl.

15. The epoxy adhesive composition of claim 1 or 2, wherein the catechol modifier is a compound of formula: 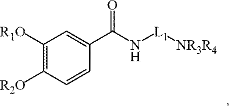
wherein R₃ and R₄ independently selected from hydrogen, alkyl, heterocyclyl, cycloalkyl, aryl or heteroaryl.

16. The epoxy adhesive composition of claim 14 or 15, wherein R₃ is hydrogen and R₄ is alkyl.

17. The epoxy adhesive composition of claim 14 or 15, wherein R₃ and R₄ are hydrogen.

18. The epoxy adhesive composition of claim 1, wherein the catechol modifier is selected from the group consisting of dopamine, N-octyl dopamine, norlaudanosoline, 2-aminobiphenyl-2,3-diol, 5,6-dihydroxyindole, coclaurine, norcoclaurine, laudanosoline, metanephrine, normetanephrine, adrenaline, and noradrenaline.

19. The epoxy adhesive composition of claim 1, wherein the catechol modifier is a N-alkylated derivative of a catechol selected from the group consisting of dopamine, N-octyl dopamine, norlaudanosoline, 2-aminobiphenyl-2,3-diol, 5,6-dihydroxyindole, coclaurine, norcoclaurine, laudanosoline, metanephrine, normetanephrine, adrenaline, and noradrenaline.

20. The epoxy adhesive composition of claim 1, wherein the catechol modifier is prepared by a process comprising:
reacting a catecholamine and a bisepoxy compound to provide a catechol modifier containing an epoxy group.

21. The epoxy adhesive composition of claim 20, wherein the catecholamine is selected from the group consisting of dopamine, N-octyl dopamine, norlaudanosoline, 2-aminobiphenyl-2,3-diol, 5,6-dihydroxyindole, coclaurine, norcoclaurine, laudanosoline, metanephrine, normetanephrine, adrenaline, and noradrenaline.

22. The epoxy adhesive composition of claim 20 or 21, wherein the bisepoxy compound is selected from the group consisting of butane diepoxide, D.E.R. 332, and Epon 828, Epon 834, D.E.R. 732, D.E.R. 736.

23. The epoxy adhesive composition of claim 1, wherein the catechol modifier is prepared by a process comprising:
reacting a catecholamine and diamine compound to provide a catechol modifier.

24. The epoxy adhesive composition of claim 23, wherein the catecholamine is protocatechuic acid or an ester thereof.

25. The epoxy adhesive composition of claims 23 or 24, wherein the diamine is selected from the group consisting of 4,7,10-trioxa-1,13-tridecanediamine (TDD), diaminobutane, and jeffamine 148.

26. The epoxy adhesive composition of any one of claims 1-25, wherein R₁ and R₂ are hydrogen.

27. The epoxy adhesive composition of any one of claims 1-25, wherein R₁ and R₂ are alkyl.

28. The epoxy adhesive composition of any one of claims 1-25, wherein one of R₁ and R₂ is hydrogen and the other is alkyl.

29. The epoxy adhesive composition of any one of claims 1-28, wherein the epoxy resin is selected from the group consisting of Epon 828 and D.E.R. 332.

30. The epoxy adhesive composition of claim 29, wherein the hardener is an amine hardener or amide hardener.

31. The epoxy adhesive composition of claim 30, wherein the amine hardener is selected from the group consisting of diaminobutane, diethylenetriamine (DETA), triethyleneglycol diamine, aminopropyl ethanolamine (APEA) and 4,7,10-trioxa-1,13-tridecanediamine (TDD).

32. The epoxy adhesive composition of any one of claims 1-31, wherein the composition further comprises one or more additives selected from the group consisting of a diluent, filler, accelerator, conductive particle, toughening agent, adhesion promoter, and stabilizer.

33. The epoxy adhesive composition of claim 32, wherein the diluent is a reactive diluent.

34. The epoxy adhesive composition of claim 33, wherein the reactive diluent is selected from the group consisting of resorcinol diglycidyl ether (RGDE), phenylglycidyl ether, butylglycidyl ether, allylglycidyl ether, butanediol diglycidyl ether, and 4,4′-Methylenebis(N,N-diglycidylaninline) (MbDGA).

35. The epoxy adhesive composition of claim 33 or 34, wherein the reactive diluent is resorcinol diglycidyl ether (RGDE).

36. The epoxy adhesive composition of claim 32, wherein the filler is selected from the group consisting of an alumino-silicate ash, chalk, talc, marble dust or limestone sand, chopped glass fiber, and powdered slate and ground olive stones.

37. The epoxy adhesive composition of claim 32, wherein the accelerator is selected from the group consisting of a modified aliphatic amine, imidazole and substituted urea.

38. The epoxy adhesive composition of claim 32, wherein the accelerator is DMP30.

39. The epoxy adhesive composition of claim 32, wherein the conductive particle is selected from the group consisting Ag powder, Ni powder, Ni flakes, Cu powder, and Ni filaments.

40. The epoxy adhesive composition of claim 32, wherein the toughening agent is selected from the group consisting of rubber and thermoplastic polymers.

41. The epoxy adhesive composition of claim 32, wherein the adhesion promoter is a silane.

42. The epoxy adhesive composition of claim 32, wherein the stabilizer is a hindered amine light stabilizer.

43. The epoxy adhesive composition of any one of claims 1-42, wherein the composition comprises from about 5% to about 30% by weight of the catechol modifier.

44. A method of coating a substrate, comprising:
(a) applying the epoxy adhesive composition of any one of claims 1-43 to the substrate; and
(b) curing the composition.

45. The method of claim 44, wherein the substrate is a metal substrate.

46. The method of claim 45, wherein the metal substrate is selected from the group consisting of aluminum and steel carbon-alloy.

47. The method of any one of claims 44-46, wherein the curing comprises heating the coated substrate to at least about 45° C.

48. The method of any one of claims 44-46, wherein the curing comprises heating the coated substrate to from about 45° C. to about 100° C.
